(19) United States
(12) Patent Application Publication
(10) Pub. No.: US 2009/0102103 A1
(43) Pub. Date: Apr. 23, 2009

(54) Infrared Light Sensors for Diagnosis and Control of Industrial Furnaces

(76) Inventors: Murray Thomson, Toronto (CA); Salvador Rego-Barcena, Toronto (CA)

Correspondence Address: RICHES, MCKENZIE & HERBERT, LLP, SUITE 1800, 2 BLOOR STREET EAST, TORONTO, ON, M4W 3J5, CA

(21) Appl. No.: 12/225,173

(22) PCT Filed: Mar. 6, 2007
(86) PCT No.: PCT/CA2007/000367

§ 371 Date: Sep. 16, 2008

(30) Foreign Application Priority Data
Mar. 28, 2006 (CA) 2541092

(51) Int. Cl. C21B 15/00; C21B 7/24; G01J 3/18

(52) U.S. Cl. 266/44; 266/99; 356/328

(57) ABSTRACT

Passive sensors, and more particularly passive infrared sensors are used to ascertain the signature of carbon dioxide and carbon monoxide in the infrared region of the light emitted by the exhaust gas and dust particles of industrial furnaces. The targeted sectors for which the sensors are to be used include steel-making, cement industries and thermal power generation, and others where combustion efficiency and the production of GHGs would be of a concern.

### SUMMARY OF THE INVENTION

The present invention relates to an apparatus for use in the analysis and control of operating parameters of industrial furnaces, and more particularly an apparatus which incorporates passive infrared sensor technology to detect the signatures of one or more off-gas stream components, and thereafter provide control signals to the furnace in response to the sensed data to better optimize furnace operating efficiencies.

### BACKGROUND OF THE INVENTION

Industrial furnaces are capital-intensive operations with major operating costs and environmental impact. To maximize energy efficiency, lower the conversion costs of raw materials, and reduce greenhouse gas (GHG) and other pollutant emissions, these large-scale combustion processes rely on various control measures which continuously alter furnace operating parameters such as oxygen content, fuel burn and flow rates, as well as the rate at which materials are introduced into the furnace itself.

Industrial combustion processes rely on control measures requiring a real-time knowledge of the furnace operating temperatures and by-product concentrations to maximize energy efficiency and pollution abatement. These measures are based on process data such as flue gas composition and temperature. As industrial furnaces are harsh environments, it is difficult to obtain process data in the vicinity of the combustion zone, such as gas temperatures and concentrations. When this data is available, however, processes may be optimized to maximize the use of energy and raw materials.

A wide range of active or extractive techniques exist to measure furnace off-gas composition where, for example, a sample of gas is removed under vacuum to a remote location for analysis. One such example is the EFSOP™ process optimization system developed by Techint-Goodfellow Technologies Inc. initially for electric arc furnaces (EAF) in the steel sector. This system relies on an extractive probe to continuously sample the off-gas for subsequent analysis to determine the concentrations of CO, CO₂, O₂, H₂ and other constituents in the flue gas, and thereafter adjusting the furnace operating parameters to maximize energy savings and other process performance parameters. These extractive sampling methods can operate continuously however there is a delay of typically 30 seconds or less to allow for sample extraction, gas conditioning and chemical analysis. Extractive technologies are limited however since they can not measure the temperature of off-gasses leaving the furnace.

Tunable diode laser (TDL) spectroscopy is another option for obtaining industrial furnace process data with measurement response times of about one second. This optical technology can in theory detect the concentration of H₂O, CO and other constituent gasses. Unlike extractive methods, insitu TDL technology can also measure flue gas temperatures.

In industrial furnace systems such as steel-making furnaces, reheat furnaces, cement kilns, glass manufacture, pulp and paper production and thermal power generation, the presence of high temperatures and sometimes corrosive gases plus excessive amounts of dust particles in flue gasses pose a severe challenge to TDL and extractive techniques. For example, dust particles block filters and sample lines and interfere with the effective transmission of laser beams. In addition, TDL laser sensor applications are also challenged by optical alignment issues, particularly as a result of thermal expansion and vibrations associated with industrial furnace operations.

As a result, the main challenge to extractive gas sampling techniques is the regular maintenance required to change particle filters on the sampling line and their inability to detect flue-gas temperatures. In spite of these limitations, conventional gas extraction sensing methods such as the EFSOP system have proven successful in measuring flue gas composition in many applications. The main challenge for TDL sensors relates to transmission difficulties and alignment issues. To date TDL sensors have proved largely impractical in the presence of variable, high particle loadings which are encountered in many industrial combustion applications including steelmaking, cement and thermal power generation.

Hence, since extractive systems can measure gas composition with a time delay and can not measure off-gas temperature and TDL technology which in theory can measure gas properties with minimal delay, but which is largely ineffective because of transmission limitations, there is a need for a sensing device that can withstand the harsh working environments associated with industrial furnaces and can effectively measure flue gas temperatures and composition in real-time.

### SUMMARY OF THE INVENTION

The present invention seeks to provide a system and method which uses passive sensors, and more particularly passive light energy sensors in the analysis and/or control of industrial furnace operations. In a broadest embodiment, the passive sensors may advantageously be used to look for the signatures of carbon dioxide and carbon monoxide in the infrared region of the light emitted by the furnace, its exhaust gas and/or ash or dust particles of the furnace off-gas stream. The applicant has appreciated that remote operation and fast response times are the two features that set such passive sensors apart from conventional extractive and laser-based counterparts. Preferably, the present invention incorporates sensor assembly having one or more passive optical and/or IR sensors which are operable to retrieve an energy signature from visible or infrared light emitted by a furnace flame, off-gas stream component such as a furnace bi-product, a waste gas and/or ash, dust or other solid particles entrained therein. Most preferably, the sensors include pyroelectric or photoconductive detectors having short measurement times (e.g., as little as one reading per second), and wherein the analyzed data may be used to extrapolate furnace conditions such as the range of concentrations that may be retrieved for CO₂.

The sensor assembly may be used in the monitoring and/or control of a variety of different types of industrial furnaces including, without restriction, those used in steel-making, cement production, thermal power generation, or other industrial furnace applications where process efficiency could be increased by the measurement of off-gas chemical and thermal properties and the production of green house gasses and other pollutants would be of a concern. The applicant has appreciated that by controlling operating parameters of such furnaces in response to the radiation energy signature of the furnace flame and/or off-gas stream components, it is possible to continuously adjust the furnace operations to maximize combustion efficiency and thereby minimize environmental impact. In particular, depending upon changes in detected radiation signatures, furnace operating parameters including, without restriction, burn or introduction rates of fuel, amounts of introduced oxygen or other reaction products, or furnace operating temperatures may be adjusted to maximize furnace efficiencies. Financial benefits come hand in hand with more control over process and environmental impacts. With forecasted energy efficiency increases of 1-3% or more resulting in lower energy costs, the financial sustainability of these industries will also improve making manufacturers more competitive and viable.

Another object of the invention is to develop a real-time industrial furnace control and optimization system using one or more infrared sensors, and wherein furnace operation performance is continuously monitored and/or adapted. More preferably, the furnace control systems incorporate one or more passive sensors that operate in conjunction with a system output to provide indications of real-time concentration and/or temperature data in exhaust gases with high dust content, either in conjunction with or without extraction systems for analysis of an extracted furnace gas sample.

Accordingly, in one aspect the present invention resides in a method of using an IR sensor assembly to control the operating parameters of a steelmaking furnace, the furnace having a vessel for heating an iron containing bath and a lance selectively operable to inject oxygen into the bath,

the IR sensor assembly being located proximate to said vessel and an off-gas stream from the bath, the sensor assembly including,
a spectrometer positioned for collecting and dispersing radiation energy from said off-gas stream into a plurality different wavelengths,
an infrared sensor configured to detect an infrared signature of an off-gas stream component over a range of said wavelengths selected at between about 3 and 6 microns, and
an output to output the detected infrared signature as sensed signature data correlated to the temperature of the off-gas stream component,

whereby when said furnace is operated to heat and refine said bath,

activating the sensor assembly to output sensed signature data correlated to a temperature of the off-gas stream component,

activating said lance to inject oxygen into the bath while the sensed signature data correlates at least to a first predetermined flue-gas temperature,

and upon said sensed signature data correlating to a second predetermined temperature which is different from said first temperature, deactivating said lance.

In another aspect the present invention resides in a method of using a passive sensor assembly to control operating parameters of an industrial furnace,

the sensor assembly being located remotely and in a visual line of sight with the furnace off-gas stream immediately adjacent the furnace and including,
a housing having a window opening exposed to view said off-gas stream,
a spectrometer positioned in said housing for collecting and dispersing radiation energy from said off-gas stream into a plurality different wavelengths,
an infrared sensor optically coupled to said spectrometer and configured to detect an infrared signature of an off-gas stream component over a range of said wavelengths selected at between about 3.7 and 5.0 microns, said off-gas stream component being selected from the group consisting of CO gas, CO₂ gas and entrained solid particles, and an output to output the detected infrared signature as sensed signature data correlated to the temperature of the off-gas stream component,

whereby during operation of said furnace, activating the sensor assembly to collect said infrared signature;

outputting sensed signature data as data correlated to a temperature of the off-gas stream component;

comparing the component temperature data with predetermined data, and adjusting the furnace operating parameters in response to the comparison.

In a further aspect, the present invention resides in a furnace control system for controlling the operating parameters of an industrial furnace, the system including,

a housing having a window opening therethrough, the opening exposed to an off-gas stream of said furnace and allowing radiation energy into said housing,

a spectrometer positioned in said housing for receiving and dispersing radiation energy from said off-gas stream into a plurality different wavelengths,

an infrared sensor optically coupled to the spectrometer for detecting an infrared signature of an off-gas stream component in a range of said wavelengths selected at between about 3 and 6 microns, and outputting the detected infrared signature as sensed signature data,

an output for converting the sensed signature data as temperature output data indicative of the temperature of a furnace off-gas stream component.

In yet another aspect, the present invention resides in a method of controlling a basic oxygen furnace (BOF) for use in steelmaking, the furnace having a vessel for forging a molten iron bath, and a lance selectively operable to inject oxygen into the bath,

an IR sensor assembly being located proximate to an air gap adjacent said vessel,

the sensor assembly including a housing having a window positioned adjacent to view an off-gas stream from the bath,
a spectrometer located in the housing for collecting and dispersing radiation energy from said off-gas stream into a plurality different wavelengths,
an infrared sensor configured to detect an infrared signature of an off-gas stream component over a range of said wavelengths selected at between about 3.7 and 5 microns, and
an output operable to output the detected infrared signature as data correlated to the temperature of the off-gas component on a least-squared optimization method in accordance with the formula,

$${R}_{gas}^{2} = {\sum }_{λɛ gas} {R}_{λ}^{2} = {\sum }_{λɛ gas} {[ {B}_{λ} ( T ) - {I}_{λ} ( T ) ]}^{2} \qquad Formula ( 1 )$$

and wherein the retrieved temperature is selected at that for which R² is smallest,

whereby in operation of said furnace,

activating the sensor assembly to output data correlated to a temperature of the off-gas stream component,

activating said lance to inject oxygen into the bath while the sensed signature data correlates at least to a first predetermined temperature,

and upon said sensed signature data correlating to a second predetermined temperature which selected less than the first predetermined temperature by a threshold amount, deactivating said lance.

### BRIEF DESCRIPTION OF THE DRAWINGS

Reference may be had to the following detailed description taken together with the accompanying drawings in which:

FIGS. 1a and 1b show schematically the experimental and modeling results for a premixed methane flame in accordance with the present invention;

FIG. 2 shows schematically a furnace control system used in the operation and control of a steel-making furnace in accordance a preferred embodiment of the invention;

FIG. 3 shows an enlarged schematic view of the sensor assembly used in the control system of FIG. 2;

FIGS. 4A to 4D illustrates graphically test results illustrating the operation of the furnace control system of FIG. 2 in the production of high and low carbon steels; and

FIGS. 5A to 5H illustrate graphically the relationship between off-gas and particle temperatures and oxygen lance operation in the production of high and low carbon steels.

### DETAILED DESCRIPTION OF THE PREFERRED EMBODIMENTS

### Preliminary Testing

In assessing the operability of passive infrared sensors as operable to collect infrared signatures of furnace operating parameters such as the furnace flame or off-gas parameters, preliminary testing has been undertaken. In particular, preliminary analysis of furnace operations of the Ontario Power Generation (OPG) Nanticoke Generating Station Unit 4 500 MW coal-fired boiler were undertaken to confirm the operability of the present invention. Nanticoke has eight generating units each consisting of two main cycles: a combustion cycle to produce steam in the coal-fired boiler and a steam cycle to generate electricity in a steam turbine, to a capacity of 3,920 MW of electric power.

A test installation was established in the Unit 4 coal-fired boiler. An infrared sensor having a pyroelectric array detector was placed at one of the corner view-ports on level 5^{1/2}, overlooking the fireball from the rows of burners on levels 3 and 3^{1/2}. The infrared sensor was set to look straight into the furnace. Safety devices like a metal conduit and a shield with a sapphire window were also adopted to minimize the intense radiant heat from the 38 cm×25 cm opening.

In a broadest embodiment, the present invention includes one or more remote infrared sensor arrays that may be used to capture the spectral signatures of CO and CO₂ in the mid-infrared region and to retrieve gas temperatures. CO and CO₂ are good indicators of the degree of completion of a combustion reaction. In industrial furnaces and the steelmaking industry, CO and CO₂ concentrations can provide useful milestones in the operation of an EAF or a BOF.

Using an automatic data acquisition system from the pyroelectric array detector, two hundred scans were taken every three seconds over a ten minute period. Even though radiation from the water walls was assumed negligible, the presence of burning coal particles and fly ash added a blackbody-like background to the light emitted mostly by CO₂ flue-gas stream. It was assumed that CO in the fireball would be below 1000 ppm and judging from the premixed burner experiments, CO's light emission would not be distinguishable from that of CO₂. The concentration of CO₂ above the fireball was estimated to be around 14% and the gas temperature about 1600° K. From the view port to a dividing wall inside the furnace there was a distance of 14 m.

RADCAL™ modelling determined CO₂ to be “saturated”, i.e., emit like a blackbody in those conditions, with its spectral signature (between 4.2 μm and 4.7 μm) superimposed from the continuous radiation of solid particles in the gas only if the emissivity of the latter is less than one, since both gases and particles would be at the same temperature. For an emissivity of one a simple continuous blackbody curve is expected.

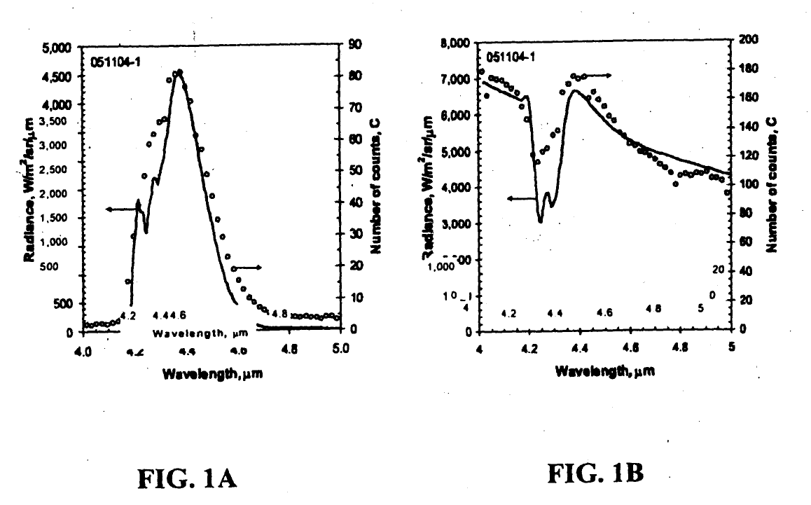

In preliminary testing, two hundred scans were taken over 10 minutes of steady operation of the furnace from a corner view-port overlooking three rows of burners. The acquired data confirmed that infrared sensors were sensitive enough to detect the infrared signature of small quantities of CO that fluctuate in time in the region above the burners. FIGS. 1A and 1B illustrate graphically the test results wherein C: refers to number of counts at a pixel position from the infrared sensor (measure of spectral irradiance); Cₒ refers to number of counts at a pixel position from the infrared sensor when the infrared source is directly in front of the spectrometer's entrance slit (measure of spectral irradiance).

Gas radiation occurs in bands over certain wavelengths. Spectral modeling shows signatures of CO and CO₂ at room and high temperatures in the 3 μm to 5 μm region, and more preferably, the 4 μm to 5 μm region which are caused by their rotational-vibrational molecular transitions. Therefore the sensors are selected as an array of pyroelectric detectors which capture irradiance (light intensity) versus wavelength in the mid-infrared. The applicants have appreciated that array sensor by IR Microsystems consisting of 64 pixels (each pixel being a pyroelectric detector) is well suited to this application and is relatively inexpensive.

To match the modeled signatures of CO and CO₂ a wavelength position is assigned to each of the 64 pixels on the detector array. Two narrow band pass filters with centre wavelengths 3.906 μm and 4.594 μm may be used to set the spectral position of two pixels. A transmission experiment (C/Cₒ) involved recording the number of counts produced by an infrared light source with the narrow band pass filter (C) and without the filter (Cₒ). From these two data points a linear relationship between pixel number and wavelength was derived in order to assign a wavelength position to all the pixels on the detector array. The measured wavelength range was from 3.711 μm to 4.987 μm, with a pixel width of 20.26 nm.

Contrary to laser spectroscopy where a fraction of the laser beam shone across a flame is absorbed by CO and CO₂, light emission at signature wavelengths by the same high temperature gases may be used. The reason for the emission of radiation energy is that the flame is being observed through a gas layer at a lower temperature, i.e., the portion of the atmosphere at room temperature between the infrared detector and the flame. In this case, the source (B) and incident (I) radiance term in the 1-D Schzartchild equation become comparable.

The source term is the light emitted by high temperature CO and CO₂ and the incident radiation is either zero (e.g., in a flame-only experiment) or the blackbody-like radiance from an infrared light source placed behind the flame. In contrast, in laser spectroscopy, the source term is overpowered by the incident radiance of the laser beam and the result is an absorption-type measurement.

Light emitted by gases can become ‘saturated’ by radiating almost like a blackbody over their signature spectral bands. Saturation is a function of gas composition, gas column length and gas temperature. For instance RADCAL™ (a one-dimensional algorithm solver of the radiative heat transfer equation without scattering) predicts saturation of part of the 4.3 μm CO₂ band for a path length of 14 m and a gas temperature of 1,600° K already at a 1% CO₂ mole fraction. After total saturation of the core of the CO₂ band has occurred, the modeled CO₂ signal remains unchanged. Thus if a saturated signal for CO₂ is observed, the only retrievable information from the flame or furnace light is the minimum mole fraction at which saturation would take place. However, the response of the wings (lines of weaker strength on both sides of the band core) to changes in the CO₂ mole fraction may also be a factor. Saturation is not a problem in a setting with short path lengths (e.g., lab burners) and appears less critical for CO given the weaker emissivity of its 4.7 μm band compared to that of CO₂ at 4.3 μm. Two types of laboratory experiments have been carried out with the infrared sensor prototype: transmission experiments to measure how room temperature CO₂ in the atmosphere absorbs light from an infrared source and secondly, experiments with a premixed methane burner.

Room temperature transmission experiments showed the ability of a prototype sensor to record the spectral signature of both CO and CO₂ at relevant concentrations (e.g., 9% by vol. of each at 1 atm). In particular, a premixed methane burner produces a one-inch square flame that contains high temperature CO₂ and CO. Using a k-type thermocouple and NDIR (non-dispersive infrared absorption methods) to measure gas concentrations, the flame was characterized as having 9.4% CO₂, 1.1% CO (by vol., dry basis) and an average temperature of 1363° K. The flame was imaged alone and with an infrared source at a temperature lower than the flame's placed behind it. The left shoulder in the flame-only peak between 4.2 μm and 4.33 μm and a result of the interaction of CO₂ in the flame and in the atmosphere. It is the room temperature CO₂ that absorbs light from the infrared source behind the flame at those same wavelengths (cf. right panel).

FIGS. 1A and 1B show experimental and modeling results for a premixed methane flame imaged alone (left panel) and with an infrared light source behind it (right panel). The flame was modeled with RADCAL™ model as a 2.5 cm gas column with 9.4% CO₂, 1.1% CO (by vol.) at 1363K. The infrared source temperature—unknown in the test—was set at 1250K in the RADCAL™ program. A second flame with more CO and a similar temperature was also imaged. It contained 6% CO₂, 5.3% CO (by vol., dry basis) at an average temperature of 1338K. The structure of the flame-only plots was very similar to the that of the previous flame, indicating that the interaction of high- and room-temperature CO₂ is responsible for the overall shape.

The preliminary testing supports the assumption that in comparing the raw signal between tube furnace and Nanticoke, there should be saturated CO₂. Furthermore, looking at the time evolution of two wavelengths (averaged every five scans, i.e., every 15 seconds): one in the saturated CO₂ region (4.6 μm) and another at the bottom of the room CO₂ valley (4.2 μm), since the 4.2 μm signal stays fairly constant a change in the instrument response may be ruled out. As such, since the CO₂ signal is saturated (meaning variations in CO₂ concentrations should not change the number of counts), the only possibility is an increase in the gas temperature. In particular, an observed 18% increase in irradiance at 4.6 μm could be produced by a 9% increase in gas temperature (from 1600° K to 1750° K) as calculated by the blackbody emissive power equation. The inventors have thus appreciated that the passive approach as a sensible step in the evolution of combustion diagnostics, particularly in harsh industrial environment applications.

### Corroborative Testing

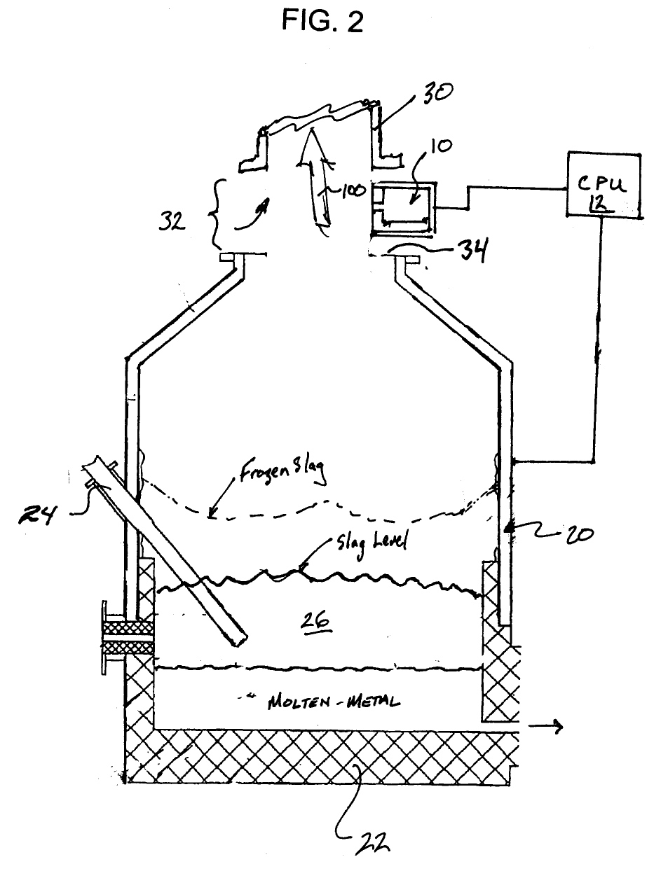

As shown in FIG. 2, the present invention thus enables a sensor assembly 10 which is used in conjunction with a processor (CPU) 12 (or other suitable integrated circuit, algorithm or other such controller) to control the operation of an industrial furnace 20. As will be described, the sensor assembly 10 is operable to effect the passive in-situ measurement of industrial furnace combustion temperatures, without requiring extraction of gas samples for later analysis. More particularly, the system 10 is operable to provide an infrared signature of one or more furnace off-gas stream components and to provide an output of the sensed signature as data correlated to the temperature of the sensed off-gas stream component, and/or concentrations of selected bi-product gasses in the off gas stream, without first requiring either extraction or pre-filtering of the sampled off gasses.

FIG. 2 shows best the industrial furnace 20 as comprising a basic oxygen furnace used in the production of steels. The furnace 20 includes a refining vessel 22 having a lance 24 which extends therein and which is used to introduce oxygen into a molten slag bath 26 during furnace 20 operation. The sensor assembly 10 is positioned near the furnace exhaust port 30 immediately adjacent to the top of the vessel 22. Most preferably, the sensor assembly 10 is positioned to view the off-gas stream exiting the vessel in proximity to the air gap 32 between a top opening 34 in the furnace vessel 22, and the exhaust port 30 where, for example, atmospheric air is entrained in the off-gas stream 100 emitted from the furnace 20.

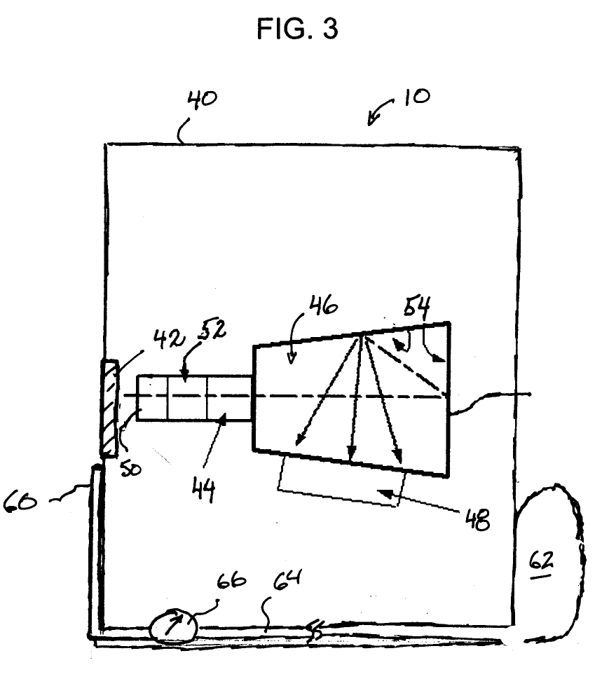

The sensor assembly 10 is shown best in FIG. 3 as including a stainless steel sealed housing 40 which includes a sapphire window 42 open to the off-gas stream 100. Within the housing 40 are positioned a lens tube 44, a spectrometer 46 and a pyroelectric detector as an IR sensor 48. The lens tube 44 is optically connected to the window 42 and most preferably incorporates a 10 Hz mechanical chopper or similar electronic device. The tube 44 further includes a focusing lens 50 and long pass filter 52 operable to permit wave length transmissions in the range of 3.6 to 7.13 microns.

Although a lens tube 44 integrating a 10 Hz mechanical chopper and a long pass filter (3.60 μm to 6.89 μm) is preferred, other lens tube 44 configurations and chopper devices may also be used. The filter 52 is preferably used to block wavelengths between 2 μm and 2.5 μm whose second order from the reflection on the spectrometer's grating would fall in the 3.7 μm to 5 μm region of interest. In this regard, a long pass filter along with a 75 line/mm diffraction grating blazed at 4.65 μm limits the overall wavelength range covered by the assembly 10 to 3.71 μm to 4.99 μm.

The spectrometer 46 most preferably is a defraction grating spectrometer having grating surfaces 54. The grating spectrometer 26 (such as the Oriel MS 125™) with a 120 mm focal length or such similar device is provided as the dispersive device for the infrared sensor 48. The spectrometer 46 is configured to achieve 75_{L}/ml grating blazed at 4.65 microns, with light from the lens tube 44 split into its individual frequencies by grating surfaces 54.

The infrared sensor (proelectric detector) 48 is provided as an infrared sensor optically coupled to the spectrometer 46. The sensor 48 is most preferably but not necessarily a 64 pixel detector, as for example is sold by IR Microsystems. The pixel sensor array of the sensor 48 relays intensity of each frequency to the processor 12 for modelling to provide temperature measurement determination.

FIG. 3 shows the sensor assembly 10 best as optionally including an air outlet nozzle 60 positioned adjacent the window 42. The outlet nozzle 60 is provided in fluid communication with a pressurized air or other suitable gas supply 62 by way of a conduit tube 64. A valve 66 is provided which is selectively operable to permit periodic air flow through the tube 64 and outwardly from the nozzle 60. The activation of the valve 66 to directs a pressurized air flow onto the surface of the window 42 to assist in dislodging any fly-ash, dust, debris or other such particulate matter which may accumulate thereon.

As will be described by analyzing the infrared signature emitted by furnace off-gas and dust particles in the off-gas stream 100 using the infrared sensor 48, the system 10 is operable to provide data which is indicative of current furnace operating parameters. A comparison of the sensed data against stored pre-determined optimal values may thus be used to provide control signals by way of CPU 12 to the furnace 20 to maximize operational efficiencies.

In a preferred mode of operation, the sensor assembly 10 is operable to detect the infrared signatures of fly-ash, dust and other particulate matter entrained in the off-gas stream 100. The IR sensor 48 is operable to measure gas and particle brightness temperatures in the off-gas stream 100 by analyzing the spectral radiance in the mid-infrared range. In particular, the sensor 48 is selected to measure radiation energy in the wavelength range of between about 3 and 6 μm and more preferably between 3.7 to 5.0 μm, including continuous radiation from solid particles and discrete radiation from CO and CO₂ in the combustion gas.

The array of the sensor (pyroelectric detector) 48 operates on a principle whereby a pixel of ceramic material that is exposed to changes in temperature, experiences a transient electrical flow whose magnitude is proportional to the irradiance arriving at the pixel. By chopping the incoming light components emitted from the off-gas stream 100 at a fixed frequency, (most preferably about 10 Hz in the present case) one may expose the sensor (pyroelectric detector) 48 to the required temperature changes. The raw output of the sensor 48 is in number of counts versus pixel position. The former is a measure of irradiance and the latter of wavelength position. By dividing the collected radiation energy into different wavelengths, the irradiance at each of the 64 pixels of the sensor 48 will correspond to a small subset of wavelengths in the mid-infrared range.

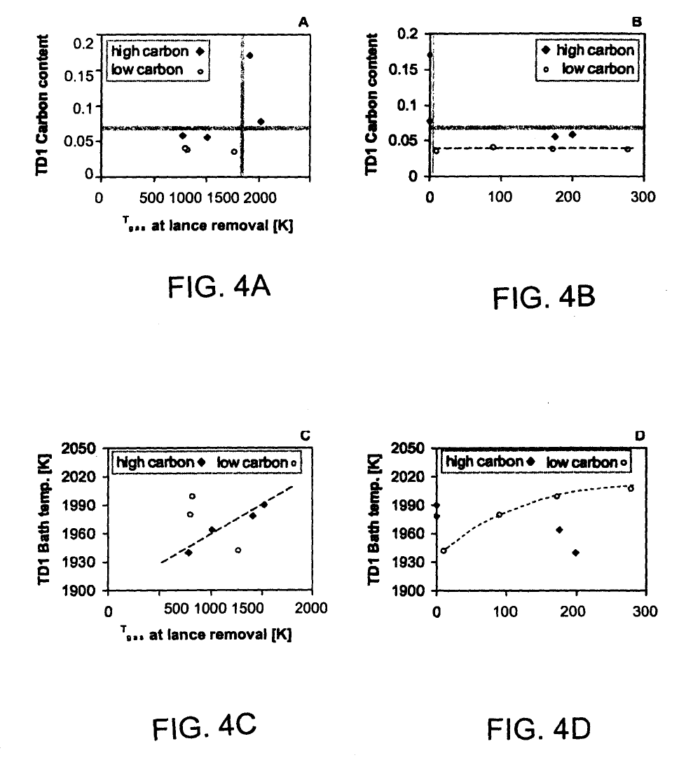

In operation, the sensor assembly 10 is used to repeatedly scan the infrared profiles of the off-gas stream 100, with the lens tube 44 used to collect the radiation emitted from the off-gas stream 100 through window 42. The collected radiation is transmitted via lens tube 44 to the grating spectrometer 46 where it is dispersed into different wavelengths onto the linear array sensor 48. Each scan, i.e., the raw data is collected by the IR sensor 48 is undertaken at least every 10 second, and preferably every second, and consists of counts versus pixel information. As will be described, the scanned data is provided to the controller 12 where radiance and wavelength calibration procedures are used to convert counts into spectral radiance (W/m₂/μ/sr) data and pixel position into spectral position data (i.e., wavelengths; measured in μm, where 1 μm=1×10⁻⁶ m). Thus, a calibrated scan may be plotted as x-y plot of spectral radiance versus wavelength in the mid-infrared as, for example, is shown in FIGS. 4A and 4B.

### Method of Temperature Retrieval: T_{gas} and T_{bri}

The applicant has appreciated that there are three distinct spectral regions that fall between 3.7 μm and 5.0 μm. In order of increasing wavelength, these regions are characterized primarily by (a) particle-only radiation that is gray due to scattering and the gray nature of the particles [3.8-4.1 μm]; (b) a significant decrease in radiation due to absorption by room temperature CO₂; and (c) saturated or blackbody radiation from CO, CO₂ and particles at the off-gas stream [4.56-4.7 μm].

To determine the physical temperature of the gas and particle mixture and the brightness temperature of particles entrained in the off-gas stream 100, particles and combustion gases are assumed to be locally isothermal, and the gaseous radiation between 4.56 μm and 4.7 μm is presumed saturated over the expected range of temperatures in the combustion gap 32. In addition, the volume fraction of particles in the line of sight of the collecting tube 44, and the path length of the gas column are assumed to yield values of the optical depth well above unity in the particle region (i.e., optically thick medium).

Temperature calculation is effected by the CPU 12 based on a least-squared optimization method that compares the theoretical blackbody radiance from Planck's law, B_{λ}(T), and the measured raw data after radiance calibration, I_{λ}(T). An average over the gaseous spectral region [4.56-4.7 μm] of the regression variable

$${R}_{gas}^{2} = {\sum }_{λɛ gas} {R}_{λ}^{2} = {\sum }_{λɛ gas} {[ {B}_{λ} ( T ) - {I}_{λ} ( T ) ]}^{2} \qquad Formula ( 1 )$$

This is done for a series of plausible temperatures (e.g., between 500° K and 2000° K). The retrieved temperature (T_{gas}) is that for which R² is smallest.

The brightness temperature of the entrained off-gas particles is not preset as equal to the particle physical temperature as, in general, particles are not perfect blackbodies in the mid-IR, i.e., ε_{par, λ}<1. The physical temperature of the particles (T_{medium}) is assumed to be the same as the gas at a specific location in the field of view (ie. at air gap 32). The particle brightness temperature (T_{bri}) is the temperature of a blackbody that would match the spectral radiance from the gray medium, as calculated by Formula (2) as follows:

I_{λ}(T_{medium})=ε_{eff}B_{λ}(T_{medium})=B_{λ}(T_{bri}), Formula (2)

where T_{medium}>T_{bri} and ε_{eff} is the effective emissivity of particles, which is a function of their physical emissivity. For a blackbody both its physical and brightness temperatures are the same. The particle brightness temperature is retrieved from an analogous regression variable R²ₚₐᵣ Formula 1) with I_{λ} and B_{λ} from the wavelength range λₚₐᵣ ε[3.8-4.1 μm].

It has been appreciated that the radiation measured by the IR sensor 48 in the gaseous spectral region will follow that of a blackbody at T_{gas}. Furthermore, the measured radiance in the particle region will be gray. Thus, two temperatures can be retrieved from the spectral data in each scan, T_{gas} (=T_{medium}) and T_{bri}.

### BOF Process Description

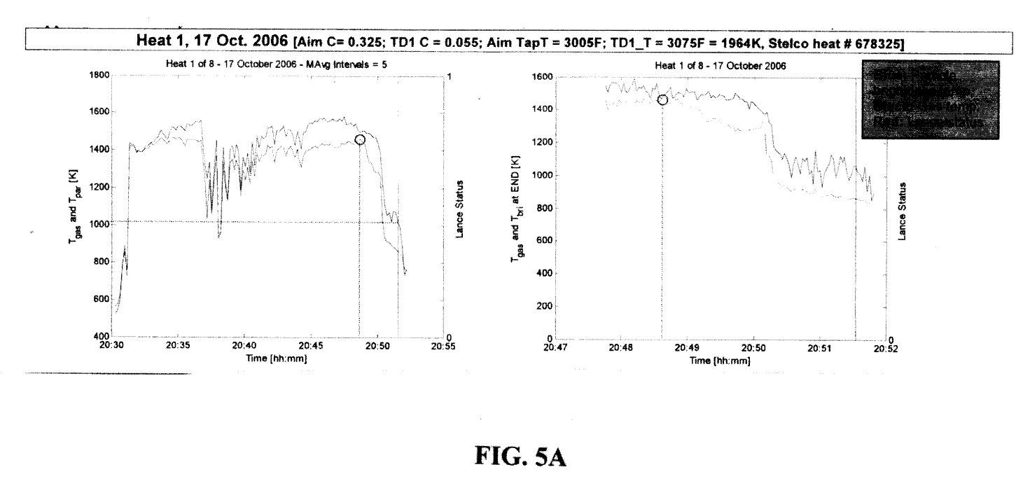

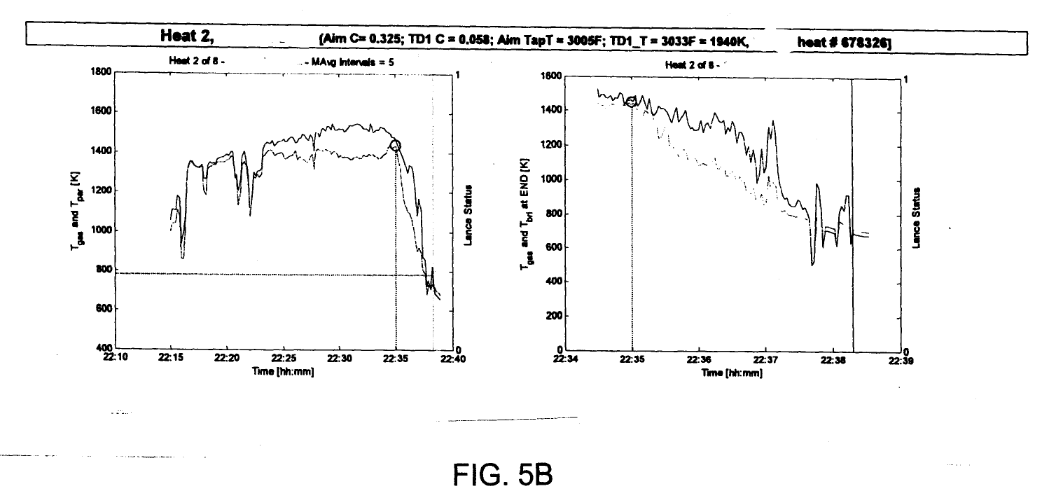

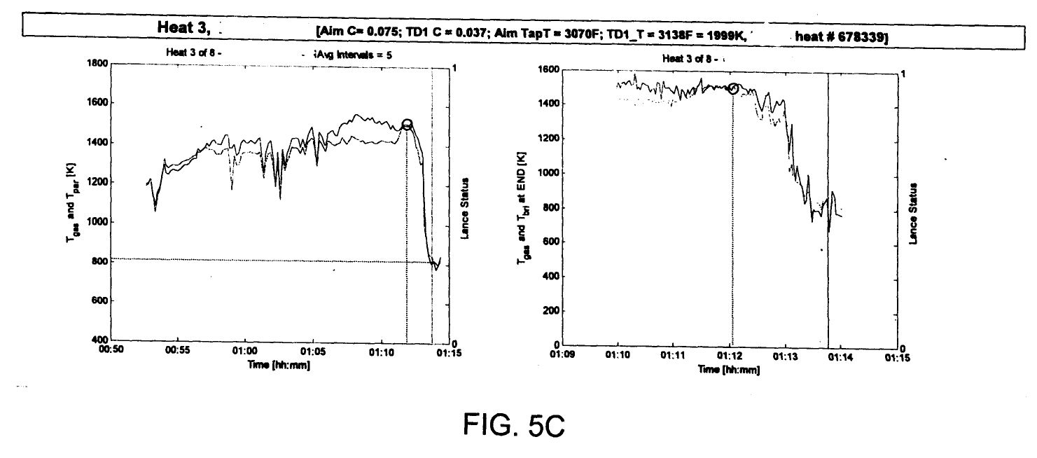

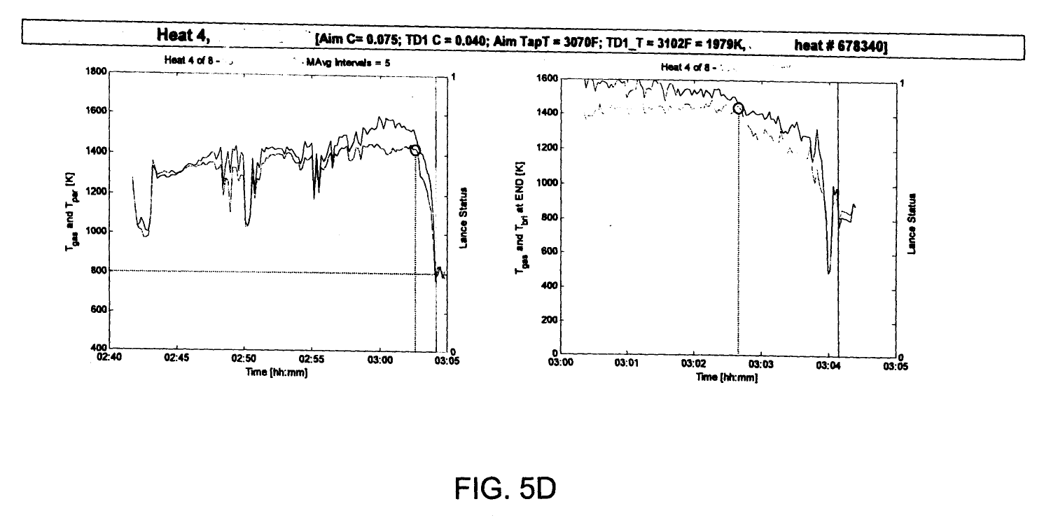

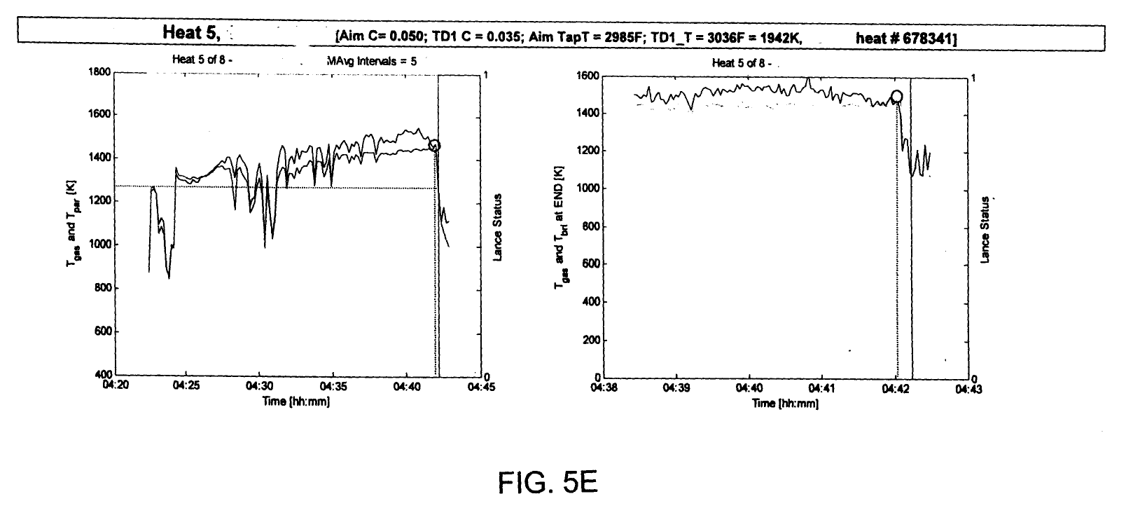

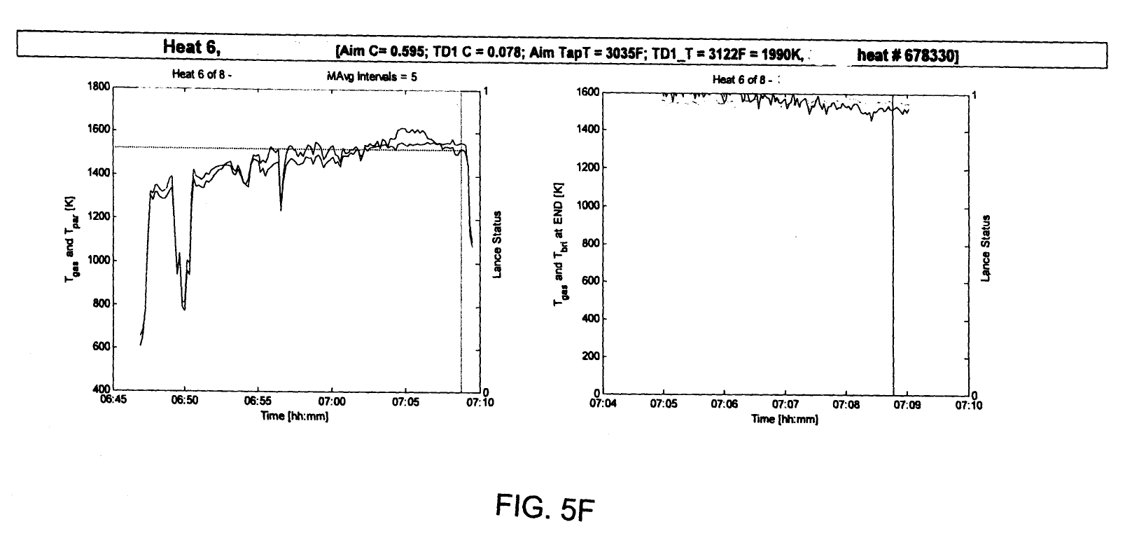

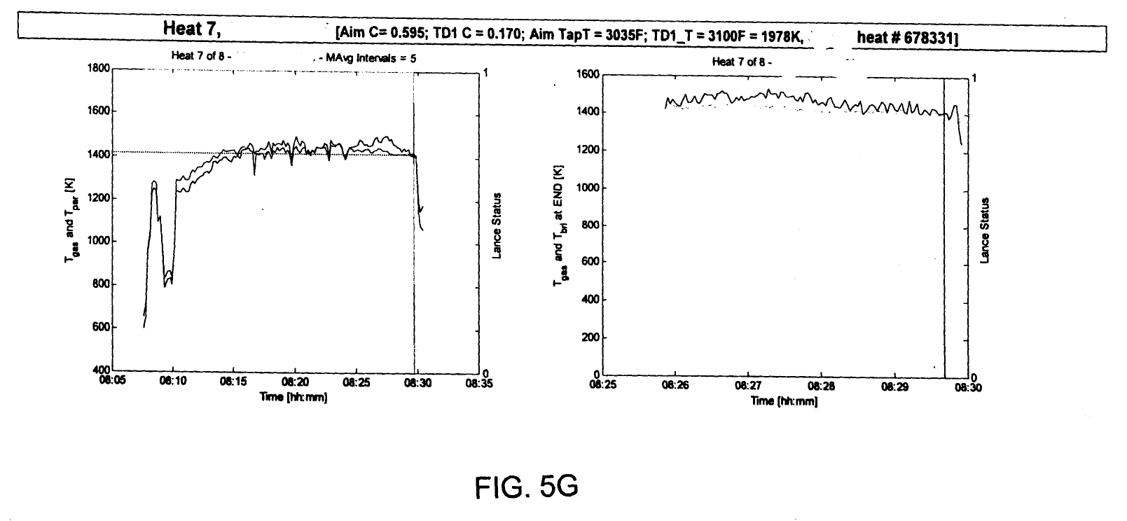

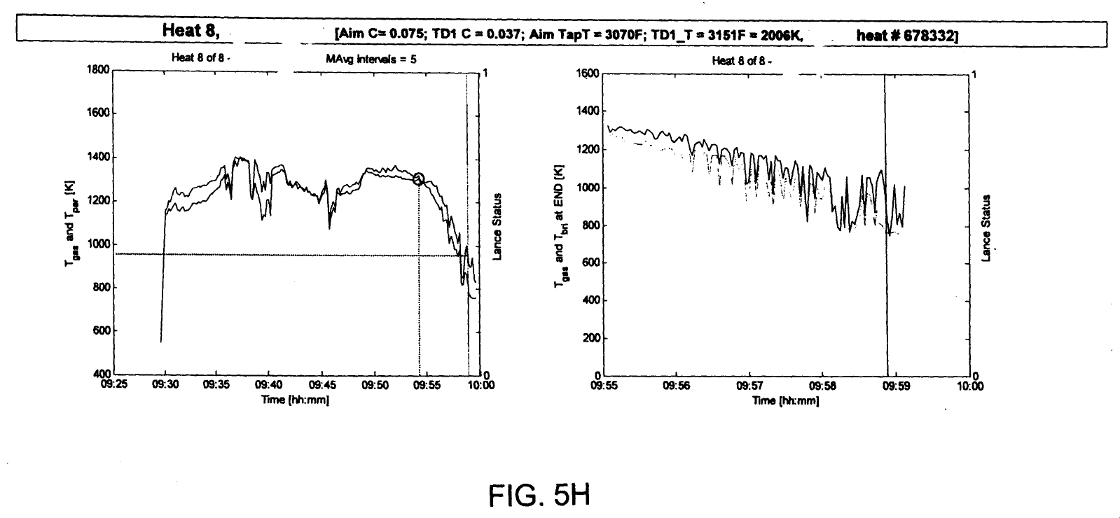

In a series of experimental batch or heat production heats represented by FIGS. 5A to 5H hereto, molten carbon saturated pig iron (with or without solid scrap steel and other additives) was refined in the vessel 22, and which is approximately 9 meters high and 3 meters in diameter. During each heat, upon injecting oxygen through the lance 24 into the bath, carbon in the molten pig iron is oxidized to CO thereby refining the carbon saturated iron into molten steel. The injected O₂ refines the bath by reacting preferentially with strong oxide formers such as silicon and manganese present as impurities in the pig iron as well as any carbon in the bath 27 (from the carbon saturated pig iron and the scrap steel, if present) to form bubbles of carbon monoxide (CO) that rise through the slag and forms the off-gas exiting the top of the vessel 22. At the upper mouth 34 of the vessel 22, CO and possibly relatively minor amounts of CO₂ formed by the further oxidation of CO and any solid particles that are entrained in this off-gas stream 100, are directed upwards where the remaining CO is combusted to CO₂ by reaction with oxygen introduced as entrained air entering at gap 32. The exhaust gas is subsequently cooled and cleaned of residual dust before it is released to the atmosphere.

After the processing, the molten steel may be transferred to a ladle furnace (not shown) where more materials are added to fine tune the final composition of the steel. In general, the temperature of the steel after the BOF furnace 20 has to be high enough so that the metal does not solidify as it goes through any subsequent manufacturing steps.

The box housing 40 is most preferably bolted on the furnace skirt or suitable alternative support, perpendicularly to the combustion gap 32 in order to capture the radiation energy at that location immediately where the off-gas stream 100 exits the vessel 22. The physical temperature of the gas and particles in the stream 100 (known as “T_{gas}”) and the brightness temperature of the particles entrained therein (known as “T_{bri}”) may then be measured using the sensor 48.

As the refining process proceeds, there is a point where the concentration of carbon in the molten steel reaches a threshold minimum, (at approximately 0.040 mass %, as dictated by equilibrium considerations). From then on the depletion in available carbon dissolved in the molten metal bath results in a growing proportion of the injected O₂ reacting with the iron in the bath forming iron(II) oxide (FeO), which floats above the molten metal thereby reporting to the molten slag 26. Some of this FeO in the slag can be reduced back to iron by subsequent reduction by residual carbon still remaining in the molten metal bath. This refining process releases heat, since the oxidation of silicon, manganese, carbon iron and other impurities in the bath 27 is an exothermic reaction. Coincident with the change from carbon to iron as the preferential oxidation the reaction, the gaseous flow of CO and entrained solid particles in the off-gas stream 100 decreases dramatically as the carbon reaches its minimum concentration. Heat released by the formation of FeO raises the temperature of the molten bath 26, such that the bath temperature no longer correlates to either of the two temperatures that may be measured by the IR sensor 48 at the combustion gap 32.

### Steel Furnace Process Control and Optimization

In the context of steel furnaces 20, a heat may be unsuccessful for different reasons, as for example, if the aim final carbon concentration in the refined molten metal is not met or the molten metal temperature at the end of the heat is too low for the next step in the manufacturing of steel. In these cases, the oxygen lance 24 is often reinserted back into the bath and a second batch process, known as “reblow”, is started. Reblows add to the cost of producing the final steel product because they require additional process time and result in a reduced metal yield due to further oxidation of metallic iron to the discard slag 26.

The present system 10 and method permit the implementation of process controls to avoid having to perform reblows and to optimize successful heats. In particular, by sensing the furnace off-gas constituents and temperatures directly at the combustion gap 32 in real-time, the operation of the furnace 20 may be better controlled to keep the carbon content in the bath 26 near its equilibrium minimum and the bath temperature as high as possible. Both are desirable outcomes in terms of preventing wasteful reblows and optimizing the use of oxygen as well as the time that each heat takes. All these benefits relate directly to productivity and energy savings per ton of steel produced, and a reduction in CO₂ emission per ton of steel produced.

After preliminary testing, a two-day measurement campaign for the sensor assembly 10 was undertaken. Information on eight heats was recorded, which became a secondary basis for analysis, integrating primary data from three sources:
(a) The IR sensor 48 provides T_{gas} and T_{bri} data;
(b) Techint-Goodfellow's EFSOP system provides the on/off status of the oxygen lance 24 and the CO, CO₂, O₂ and H₂ concentration of the off-gas as the heat proceeds; and
(c) The host test site provided background information the carbon content in the bath and the bath temperature at the end of each heat.

The collected information is summarized for each heat as shown in FIGS. 4A to 4D with FIGS. 5A to 5H illustrating graphically the results of each separate heat. In FIGS. 5A to 5H, the abbreviation “Tₚₐᵣ” is used to identify the brightness of particles in place of T_{bri}.

The aforementioned values are known as the first turn-down carbon content (measured in mass %) and the first turn-down bath temperature. As used herein, the term “first turn-down” refers to the first turndown of vessel 22 thereby providing the first test for temperature and carbon content of the molten metal 27 from a sample taken after the BOF vessel has been physically rotated or “turned down”.

The secondary variables of interest include T_{gas} at removal of the lance 24, i.e., when the oxygen lance status goes from 1 (on) to 0 (off), and the time interval between a significant drop in T_{bri} and the lance removal time (Δt_{T-lance}). T_{bri} is shown to steadier than T_{gas} as the heat came to an end, and, therefore, provides a clearer indicator for the drop in temperature as the heat came to an end. Nonetheless T_{gas} is the variable that is tracked as it is the physical temperature of the gas and particle mixture (see Formula 2).

Table 1 summarizes the relevant primary and secondary variables that were obtained from the eight heats. The aim carbon variable, (provided by the Host test site), is the basis for qualitatively labelling heats either as high-carbon heats or low-carbon heats.

TABLE 1
Summary of the experimental data on which the
control strategy is based.

| | | T_{gas} at lance | Aim carbon | TD1 C | TD1 T |
|---|---|---|---|---|---|
| Heat # | Δt_{T-lance} [S] | removal [K] | [mass %] | [mass %] | [K] |
| 1 | 176 | 1013 | High (0.325) | 0.055 | 1964 |
| 2 | 199 | 779 | High (0.325) | 0.058 | 1940 |
| 3 | 173 | 816 | Low (0.075) | 0.037 | 1999 |
| 4 | 90 | 800 | Low (0.075) | 0.040 | 1979 |
| 5 | 11 | 1268 | Low (0.050) | 0.035 | 1942 |
| 6 | 0₅ | 1522 | High (0.595) | 0.078 | 1990 |
| 7 | 0 | 1413 | High (0.595) | 0.170 | 1978 |
| 8 | 278 | 951⁵ | Low (0.075 | 0.037 | 2006 |

If T_{bri} did not drop before the oxygen flow to lance 24 was stopped, a value of 0 was assigned to Δt_{T-lance}. This happened in Heats 6 and 7.

The air pressure in the housing 40 that contained the IR sensor 48 was increased before Heat 7 started. Likely this started to cause more dust accumulation on the window in front of the IR Sensor. Because T_{gas} and T_{bri} for Heat 7 are very similar to those observed for the rest of the heats, there are solid grounds to believe that dust accumulation did not affect the results for Heat 7. This is, however, not the case for Heat 8. Significant dust accumulation will lower the magnitude of the retrieved temperatures, which is apparent in T_{gas} and T_{bri} for Heat 8. Since Δt_{T-lance} is based on a qualitative assessment of when T_{bri} starts to drop (regardless of its magnitude), its value for Heat 8 was taken as correct.

By correlating the two secondary variables to the data of Table 1, the graphs shown in FIGS. 4A to 4D illustrate that for the two heats (6 and 7) where T_{bri} did not drop sharply before the lance was removed, the carbon content was significantly higher. This is shown by the two data points in the top-right quadrant of FIG. 4A.

High T_{gas} at lance removal correlates with a zero value of Δt_{T-lance}. Hence the two same data points appear in the top-left quadrant of FIG. 4B. The fact that the top-left quadrant in FIG. 4A (or, alternatively, the top-right quadrant of FIG. 4B) is empty points to the conclusions that once the particle brightness temperature detected by the IR Sensor drops, the carbon content in the steel bath is close to the minimum dictated by equilibrium. This is true either for low- or high-carbon heats, (as shown by FIGS. 4A and 4B), although high-carbon heats have slightly higher carbon content at the end of the heat.

Once the carbon content is almost depleted, the oxygen from the lance 24 starts to react preferentially with iron. This switch stops the formation of CO bubbles, and the associated gas flow at the combustion gap decreases sharply. Without gas as a carrier, fewer solid particles are present and the signal measured by the IR Sensor drops sharply (FIG. 3). However, for Heats 6 and 7 the eventual decrease in gas and particle temperature was not due to the near depletion of carbon in the bath, as was the case in the other six heats, but to the removal of oxygen from the bath 27. The effect on gas flow appears to be the same. Without oxygen to oxidize the carbon in the steel, no CO is formed and vertical flow of gas and particles at the combustion gap decreases.

Heat 5 was interesting because the lance 24 was removed only 11 seconds after T_{bri} started to drop. Even though this time was short, the carbon content had already reached its minimum. This fact makes the monitoring of T_{bri} from the IR sensor 48, a very sensitive indicator to determine accurately when the carbon content in the bath has been minimized as much as one may practically expect it to drop.

The dotted line in FIG. 5B shows clearly that there is no advantage in continuing the injection oxygen into the bath once T_{bri} has dropped. Not only will the carbon content not change because it is the iron in the bath that it is being consumed, but also the increase in bath temperature will eventually level off for low-carbon heats (See FIG. 5D). In this regard, it is useful to compare the results from Heats 3 and 4, since both had identical aim carbon levels and very similar T_{gas} at lance removal. However, the oxygen flow for Heat 4 was stopped 90 s after T_{bri} started to drop, whereas it took 173 s in the case of Heat 3. Their carbon levels in mass % are virtually identical: 0.37 for Heat 3 and 0.40 for Heat 4, and their bath temperatures only differ by 20K, even though both temperatures were well above their aim tap temperature. This means that there was no benefit in continuing the oxygen flow in Heat 3 for 83 s longer than in Heat 4. In fact, the oxygen in Heat 4 itself could have been stopped 60 s earlier without much change to TD 1 C and TD 1_T. The payback in terms of optimizing oxygen usage and productivity are clear. In the case of high-carbon heats, the relationship between waiting to stop the oxygen flow after the drop in T_{bri} and the bath temperature could not be determined from only two data points (FIG. 5D Δt_{T-lance}=176 s and 199 s).

FIG. 4C illustrates the different relationship between T_{gas} at lance 24 removal and TD1_T for low- and high-carbon heats. For high-carbon heats, the data shows that a direct relationship between T_{gas} and TD1_T. It is believed is that carbon in the steel has not been completely depleted even for the two lower data points (solid diamonds, with T_{gas} at lance removal=779K [Heat 2] and 1013K [Heat 1]) and that, therefore, the reaction of oxygen and carbon is finishing while the oxidation of iron is starting. Although when the lance 24 is removed, the flow at gas and particles likely a fraction of what it was in the middle of the heat (since T_{gas} and T_{bri} dropped significantly), the basic link between T_{gas} and TD1_T is still preserved: the hotter the bath temperature, the hotter the off-gas 100 leaving the vessel 22.

On the other hand, for low-carbon heats, once gas and particles stop flowing upwards due to the switch in the combustion chemistry, there is a decoupling between T_{gas} at lance removal and TD1_T, since T_{gas} will be measuring ambient noise. Since for Heat 5, Δt_{T-lance} was very small, there was little time for the oxidation of iron. This explains why in Heat 5 T_{gas} at lance 24 removal was higher than for the other low-carbon heats while its TD1_T was the lowest.

### Control Parameters

The foregoing suggests a strategy which may be used for low- and high-carbon heats in steel production to prevent wasteful reblow processes (due to low temperature or high carbon content), and to optimize the operation of successful heats (those without reblow) which may be summarized as follows:

### Low-Carbon Heats

Stop the introduction of oxygen through lance 24 after a selected period of time (i.e. 15 seconds) has elapsed following a sharp drop in T_{bri}. This will yield consistent carbon content levels close to the practical minimum of 0.035 mass %, and which is below the aim carbon content for low-carbon heats.
If the oxygen lance 24 is not stopped, the carbon content will not appreciably decrease further; instead the iron in the bath 26 will start to oxidize, contributing to a modest rise in the bath temperature and metal yield loss. The Δt_{T-lance} may provide a measure of the steel temperature and thus one could keep the oxygen lance 24 on in order to reach the desired bath 27 temperature. However in the test heat after approximately 3 minutes from the drop in T_{bri} the temperature increase levels off and further oxygen injection becomes clearly wasteful.
More carbon may be subsequently added in the molten metal to reach the desired aim carbon for each heat.

### High-Carbon Heats

Wait for a sharp drop in T_{bri} to occur and stop the oxygen lance 24. This will yield consistent carbon content levels well below the aim carbon for high-carbon heats.
Not stopping the oxygen lance 24 at that point is wasteful since one is already below the aim carbon level and likely the bath temperature will not change by much.
More carbon may be subsequently added in molten metal to reach the desired aim carbon for each heat.

The applicant has appreciated that various benefits may be realized in steel furnace operations with the present invention, Productivity of the BOF furnace 20 may be improved since delays due to reblow can be minimized or eliminated entirely, or by using the oxygen lance 24 longer than necessary. In addition, energy usage per ton of steel produced is maximized since reblows are energy intensive and do not add to the production of more steel. Also high-purity oxygen and its injection at supersonic speeds require large energy inputs that are wasted when oxygen is not necessary any more. The tonnage of steel produced per heat can be increased since the oxidation of iron is minimized when the oxygen flow is stopped on time. As well, natural resources per ton of steel are optimized since less additives and oxygen are used when there are no reblows.

From the point of view of reducing greenhouse gasses, direct and indirect CO₂ emissions per ton of steel are minimized since less CO₂ is produced (via the combustion of CO) when there are no reblows (where carbon is added and then burned). In addition, the minimized use of the oxygen lance 24 also minimizes the indirect emission of CO₂ to the atmosphere by the conservation of fossil fuels. As well, less steel is produced if iron is oxidized, thus increasing the ratio of [CO₂ emissions/unit of steel produced].

Although the detailed description describes and illustrates various preferred embodiments, the invention is not so limited. Many modifications and variations will now occur to those skilled in the art. For a definition of the scope of the present invention, reference may be had to the appended claims.

As used herein, the following terms shall have the following meanings:
B Planck's function for a blackbody [W/m²/μm/sr]
I radiance [W/m²/μm/sr]
R² regression variable [(W/m²/μm/sr)²]
T temperature [K]
emissivity [.]
λ wavelength [μm]

Subscripts
bri brightness temperature of the particles
eff effective emissivity of the particle medium (cf.(15))
gas gas phase (CO₂ in the boiler)
medium gas-particle mixture
par particle (fly-ash and unburned coal)
λ wavelength-dependent variable

We claim:

1. A method of using an IR sensor assembly to control the operating parameters of a steelmaking furnace, the furnace having a vessel for heating an iron containing bath and a lance selectively operable to inject oxygen into the bath,
the IR sensor assembly being located proximate to said vessel and an off-gas stream from the bath, the sensor assembly including,
a spectrometer positioned for collecting and dispersing radiation energy from said off-gas stream into a plurality different wavelengths,
an infrared sensor configured to detect an infrared signature of an off-gas stream component over a range of said wavelengths selected at between about 3 and 6 microns, and
an output device to output the detected infrared signature as sensed signature data correlated to the temperature of the off-gas stream component,
whereby when said furnace is operated to heat said bath,
activating the sensor assembly to output sensed signature data correlated to a temperature of the off-gas stream component,
activating said lance to inject oxygen into the bath while the sensed signature data correlates at least to a first predetermined temperature,
and upon said sensed signature data correlating to a second predetermined temperature which is different from said first temperature, deactivating said lance.

2. The method as claimed in claim 1 wherein the steel making furnace comprises a basic oxygen furnace, and the off-gas stream component comprises entrained solid particles.

3. The method as claimed in claim 2 wherein the lance is deactivated when the difference between the first and second predetermined temperatures is at least 50° K.

4. The method as claimed in claim 3 wherein the lance is deactivated when the difference between the first and second predetermined temperatures is at least 250° K.

5. The method as claimed in claim 1 wherein the IR sensor further includes a substantially sealed housing positioned in a combustion gap of said furnace adjacent to an upper surface portion of said bath, the housing including a window and wherein said spectrometer and sensor are disposed within said housing, the spectrometer further including a focusing lens positioned adjacent said window to assist collecting said off-gas radiation energy.

6. The method as claimed in claim 1 wherein said spectrometer comprises a grating spectrometer, and said range of wavelengths is selected at between about 3.7 and 5.0 microns.

7. The method as claimed in claim 6 wherein said steel comprises a low carbon steel, said first predetermined temperature is selected at greater than about 1400° K and said second predetermined temperature is selected at less than about 1200° K.

8. The method as claimed in claim 6 wherein said infrared sensor is operated to repeatedly sense said infrared signature and output sensed signature data at a rate of at least six times per minute.

9. The method as claimed in claim 8 wherein said infrared sensor is operated to repeatedly sense said infrared signature and output sensed signature data at a rate of at least sixty times per minute.

10. The method as claimed in claim 5 wherein said sensor assembly further includes a pressurized fluid nozzle selectively operable to direct a pressurized gas stream towards exterior surface of said window to assist in dislodging any dust or debris therefrom, and at least prior to the deactivation of the lance periodically actuating said fluid nozzle.

11. A method of using a passive sensor assembly to control operating parameters of an industrial furnace,
the sensor assembly being located in a furnace off-gas stream immediately adjacent the furnace and including,
a housing having a window opening exposed to said off-gas stream,
a spectrometer positioned in said housing for collecting and dispersing radiation energy from said off-gas stream into a plurality different wavelengths,
an infrared sensor optically coupled to said spectrometer and configured to detect an infrared signature of an off-gas stream component over a range of said wavelengths selected at between about 3.7 and 5.0 microns, said off-gas stream component being selected from the group consisting of CO gas, CO₂ gas and entrained solid particles, and an output to output the detected infrared signature as sensed signature data correlated to the temperature of the off-gas stream component,
whereby during operation of said furnace, activating the sensor assembly to collect said infrared signature;
outputting sensed signature data as data correlated to a temperature of the off-gas stream component;
comparing the component temperature data with predetermined data, and adjusting the furnace operating parameters in response to the comparison.

12. The method as claimed in claim 11 wherein the off-gas stream component comprises entrained solid particles.

13. The method as claimed in claim 11 wherein said industrial furnace comprises a basic oxygen furnace for the batch production of steel, the furnace having a vessel for heating a molten iron bath and a lance selectively operable to introduce oxygen into the bath as an operating parameter of the furnace, and wherein said lance is actuated or de-activated in response to the comparison of the component temperature data and the predetermined data.

14. The method as claimed in claim 13 wherein said infrared sensor is operable to repeatedly sense said infrared signature and output sensed signature data at a rate of at least thirty times per minute, and wherein the predetermined data is a previous temperature of the off-gas stream component.

15. The method as claimed in claim 11 wherein the furnace comprises a steel making furnace having a vessel for forming a molten bath, the sensor further includes a substantially sealed housing positioned in a combustion gap of said furnace adjacent to an upper open portion of said vessel, the housing including a window, said spectrometer and sensor being disposed within said housing, the spectrometer further including a focusing lens positioned adjacent said window to assist collecting radiation energy from said off-gas stream component.

16. A furnace control system for controlling the operating parameters of an industrial furnace, the system including,
a housing having a window opening therethrough, the opening exposed to an off-gas stream of said furnace and allowing radiation energy into said housing,
a spectrometer positioned in said housing for receiving and dispersing radiation energy from said off-gas stream into a plurality different wavelengths,
an infrared sensor optically coupled to the spectrometer for detecting an infrared signature of an off-gas stream component in a range of said wavelengths selected at between about 3 and 6 microns, and outputting the detected infrared signature as sensed signature data,
an output for converting the sensed signature data as temperature output data indicative of the temperature of a furnace off-gas stream component.

17. The control system as claimed in claim 16 wherein the output comprises an integrated circuit.

18. The control system as claimed in claim 16 wherein the output is selected from a microprocessor for tabulating data and stored programming.

19. The control system as claimed in claim 16 wherein the housing comprises a substantially sealed housing, and a sapphire window positioned in the window opening immediately adjacent to said off-gas stream.

20. The control system as claimed in claim 19 further including a pressurized fluid nozzle selectively operable to direct a pressurized gas stream on an exterior surface of said sapphire window to assist in dislodging any dust or debris there from.

21. The control system as claimed in claim 16 wherein said infrared sensor comprises a pyroelectric detector having a linear pixel array, and said spectrometer comprises a grating spectrometer.

22. The control system as claimed in claim 21 wherein said off-gas stream component comprises entrained solid particles, and said range of wavelengths is selected at between about 3.7 and 5.0 microns.

23. The control system as claimed in claim 22 wherein said industrial furnace comprises a basic oxygen furnace for the batch processing of steel, the furnace further including a vessel for forming a molten bath, and a lance which is selectively operable to inject oxygen into the bath,
the sensor being positioned in a combustive gap adjacent the vessel, and further wherein the lance is selectively activatable in response to the temperature output data.

24. A method of controlling a basic oxygen furnace for use in steelmaking, the furnace having a vessel for forging a molten iron bath, and a lance selectively operable to inject oxygen into the bath,
an IR sensor assembly being located proximate to an air gap adjacent said vessel,
the sensor assembly including a housing having a window positioned adjacent to an off-gas stream from the bath,
a spectrometer located in the housing for collecting and dispersing radiation energy from said off-gas stream into a plurality different wavelengths,
an infrared sensor configured to detect an infrared signature of an off-gas stream component over a range of said wavelengths selected at between about 3.7 and 5 microns, and
an output operable to output the detected infrared signature as data correlated to the temperature of the off-gas component on a least-squared optimization method in accordance with the formula,
$${R}_{gas}^{2} = {\sum }_{λɛ gas} {R}_{λ}^{2} = {\sum }_{λɛ gas} {[ {B}_{λ} ( T ) - {I}_{λ} ( T ) ]}^{2} \qquad Formula ( 1 )$$
and wherein the retrieved temperature is selected at that for which R² is smallest,
whereby in operation of said furnace,
activating the sensor assembly to output data correlated to a temperature of the off-gas stream component,
activating said lance to inject oxygen into the bath while the sensed signature data correlates at least to a first predetermined temperature,
and upon said sensed signature data correlating to a second predetermined temperature which selected less than the first predetermined temperature by a threshold amount, deactivating said lance.

25. The method as claimed in claim 24 wherein threshold amount is selected at greater than about 75° K.

26. The method as claimed in claim 24 wherein threshold amount is selected at greater than about 200° K.
